(19) United States
(12) Patent Application Publication
(10) Pub. No.: US 2012/0030260 A1
(43) Pub. Date: Feb. 2, 2012

(54) SCALABLE AND PARALLEL GARBAGE COLLECTION METHOD AND SYSTEM FOR INCREMENTAL BACKUPS WITH DATA DE-DUPLICATION

(76) Inventors: Maohua Lu, Greenbelt, MD (US); Tzi-Cker Chiueh, Taipei (TW)

(21) Appl. No.: 12/846,824

(22) Filed: Jul. 30, 2010

(51) Int. Cl. G06F 12/00; G06F 17/00

(52) U.S. Cl. 707/820; 707/E17.005

(57) ABSTRACT

In accordance with exemplary embodiments, a scalable and parallel garbage collection system for incremental backups with data de-duplication may be implemented with a memory and a processor. The memory may store a changed list at a current time, a before-image list including previous versions of the first overwrite at a current time for each of a plurality of overwritten physical blocks in said storage system, a garbage collection related change list and a recycle list. With these lists configured in the memory, the processor limits the garbage collection to incremental changes and distributes garbage collection tasks to a plurality of participating nodes. For garbage collection, each physical block may associate with an expiration time and a reference count. When the reference count drops to zero, the physical blocks are recycled based on the expiration time.

### TECHNICAL FIELD

The disclosure generally relates to a scalable and parallel garbage collection method and system for incremental backups with data de-duplication.

### BACKGROUND

Backup images are created and expired over time. Logical volume is the basic unit of backup, and each backup logical volume may have multiple backup images. A logical-to-physical (L2P) map may map all logical block numbers in a logical volume to corresponding physical blocks. A physical storage may have a P-array to store per-physical block information. Most data de-duplication techniques focus on the full backups, where all logical blocks of a logical volume are de-duplicated with existing stored blocks even if only a small portion of all logical blocks have been changed.

The underlying physical space of expired backup images needs to be garbage collected. One indispensable component in data de-duplication systems is garbage collection. The size of garbage collection information is proportional to the size of the changed blocks. Therefore, the garbage collection may save a lot of disk inputs/outputs to access garbage-collection-related metadata. To further reduce the size of garbage-collection-related metadata on each individual node, the metadata may be, for example, further distributed to multiple data nodes based on a consistent hash of fingerprints.

One known technique is mark-and-sweep garbage collection. In the mark-and-sweep garbage collection, physical blocks not used by any live L2P map is safe to be reclaimed. No information is maintained at the backup time, and L2P maps of all live backup images are scanned. Also, the physical block in P-array is marked as used for random updates or I/O operation triggered, and P-array may be scanned to detect non-used entries and add them to a to-reclaim list.

One known technique is counter-based garbage collection. In the counter-based garbage collection, offloading the random marking in sweep-and-mark is from garbage collection time to backup time. The counter of all physical blocks referred by the backup image increments at creation time of a backup image. In turn, the counter of all physical blocks referred by the backup image decrements at the expiration time. Each P-array entry may have a counter, and P-array to may be scanned to detect blocks having a counter value 0. No aliveness information will be maintained. In one exemplary scheme, only blocks in incremental backups are updated with the counter. Each time a backup image is recycled, full logical-to-physical (L2P) maps of logical volumes are checked to find out those blocks that can not be reached by any logical block address of any logical volume. This scheme is not scalable because all L2P maps need to be checked.

One known technique is expiration-time-based garbage collection. In the expiration-time-based d garbage collection, metadata updates are avoided at the expiration time of a backup image. Each P-array entry has an expiration time. Expiration times of all referred P-array entries are updated at the backup creation time, while P-array may be scanned to detect expired blocks at the garbage collection time. In one exemplary scheme, each time an object is referred, its timeout is updated and propagated properly based on backward pointers. During the garbage collection, those objects with an expired timeout are garbage collected. This scheme is also not scalable when the amount of objects is large as in the backup storage system. All physical blocks pointed by a L2P map of a volume have to update their timeout values.

Distributed counter-based garbage collection may be understood as described in “A Survey of Distributed Garbage Collection Techniques”, in Proceedings of International Workshop on Memory Management 1995. For example, one known distributed garbage collection technique is to combine weighted reference counting with mark-and-sweep for collecting garbage cycles. These distributed garbage collection techniques in the survey focus on tracing the dependencies among distributed nodes in a fault-tolerant fashion. A problem with the distributed tracing might be to synchronize the distributed mark phase with independent sweep phase. Another problem of fault-tolerant distributed tracing might be to maintain the consistency of entry items and exit items.

Scalable and parallel garbage collection for incremental backups with data de-duplication is desired because garbage collection determines the throughput of recycling free data blocks.

### SUMMARY

The disclosed exemplary embodiments may provide a scalable and parallel garbage collection method and system for incremental backups with data de-duplication.

In an exemplary embodiment, the disclosed relates to a scalable and parallel garbage collection system for incremental backups with data de-duplication on a storage system. The method comprises: inputting a change list (CL) at a current time and a before-image list (BIL) including previous versions of the first overwrite at the current time for each of a plurality overwritten physical blocks in the storage system and associating each of the plurality of overwritten blocks with a reference count (RC) due to de-duplication, and an expiration time (ET); for those physical blocks referred in the CL of the plurality of overwritten blocks, incrementing their associated RCs and updating their associated ETs, and. for those physical blocks referred in the BIL of the plurality of overwritten blocks, decrementing their associated RCs and updating their associated ETs; adding all these physical blocks referred in CL or BIL to a garbage collection related change list (GC-CL); and distributing metadata <ET, RC> of per-physical block to a plurality of participating nodes with each participating node responsible for garbage collecting those physical blocks that are mapped to it.

In another exemplary embodiment, the disclosed relates to a scalable and parallel garbage collection system for incremental backups with data de-duplication. The system comprises a memory and a processor. The memory stores a CL at a current time, a BIL including previous versions of the first overwrite at a current time for each of a plurality of overwritten physical blocks in a storage system, a GC-CL to record related information for incremental changed physical blocks and a RL to garbage collect the physical blocks to be recycled. Processor perform: associating each of the plurality of overwritten blocks with a RC due to de-duplication, and an ET; for those physical blocks referred in the CL of the plurality of overwritten blocks, incrementing their associated RCs and updating their associated ETs, and. for those physical blocks in the BIL of the plurality of overwritten blocks, decrementing their associated RCs and updating their associated ETs; adding all these physical blocks referred in the CL or the BIL to the GC-CL. The system further distributes metadata <ET, RC> of per-physical block to a plurality of participating nodes with each participating node responsible for garbage collecting those physical blocks that are mapped to it.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 shows an exemplary triple of (RC, ET, FRT) for an exemplary changed block, consistent with certain disclosed embodiments.

FIGS. 2A-2D show a working example of updating GC-CL and RL for backup images A-D at backup time, consistent with certain disclosed embodiments.

FIG. 3 shows an exemplary flowchart of a scalable and parallel garbage collection method for incremental backups with data de-duplication on a storage system, consistent with certain disclosed embodiments.

FIG. 4 shows an exemplary flowchart illustrating how the triple of ET, RC and FRT is updated for garbage collection, consistent with certain disclosed embodiments.

FIG. 5 shows an exemplary flowchart illustrating how garbage collection proceeds based on the RL, consistent with certain disclosed embodiments.

FIG. 6 shows an exemplary schematic view illustrating how GC-CL and RL are distributed to participating parallel nodes based on the consistent hashing of the fingerprint of the physical block, consistent with certain disclosed embodiments.

FIG. 7 shows how parallel garbage collection works with participating parallel nodes, consistent with certain disclosed embodiments.

FIG. 8 shows a working example on how to distribute a GC-CL to 4 participating nodes, according to the flowchart of FIG. 6, consistent with certain disclosed embodiments.

FIG. 9 shows an exemplary scalable and parallel garbage collection system for incremental backups with data de-duplication, consistent with certain disclosed embodiments.

### DETAILED DESCRIPTION OF THE EXEMPLARY EMBODIMENTS

After data de-duplication, multiple logical addresses may point to the same physical block. Garbage collection of physical blocks may be time-consuming due to the large amount of physical blocks. Most physical blocks are alive across images, and they are not candidates for reclamation. For an overwritten block, it may be garbage collected if the backup image the block belongs to expires or the block is not shared among backup images due to de-duplication. The disclosed exemplary embodiments may provide a system and method to make garbage collection scalable for incremental backup with de-duplication. The disclosed exemplary embodiments employ two techniques. One is to limit the scope of garbage collection to incremental changes. The other is to distribute garbage collection tasks to all participating nodes. Each physical block may have at least two fields for use of garbage collection. One is the expiration time and the other is the reference count.

When the reference count drops to zero, the physical blocks are recycled based on the expiration time. At the backup time, the reference count for a counter is decremented for overwritten physical blocks and incremented for new physical blocks, and their expiration time for those physical blocks will be updated accordingly and stored in a change list. At the garbage collection time, those blocks with the reference count dropping to zero and expiration time having expired are reclaimed. In other words, the reclaimed physical blocks are recycled based on their expiration time when they have zero reference count.

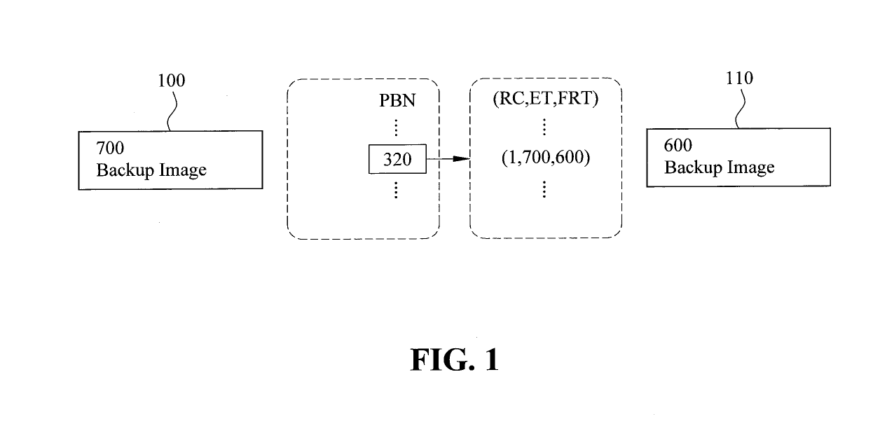

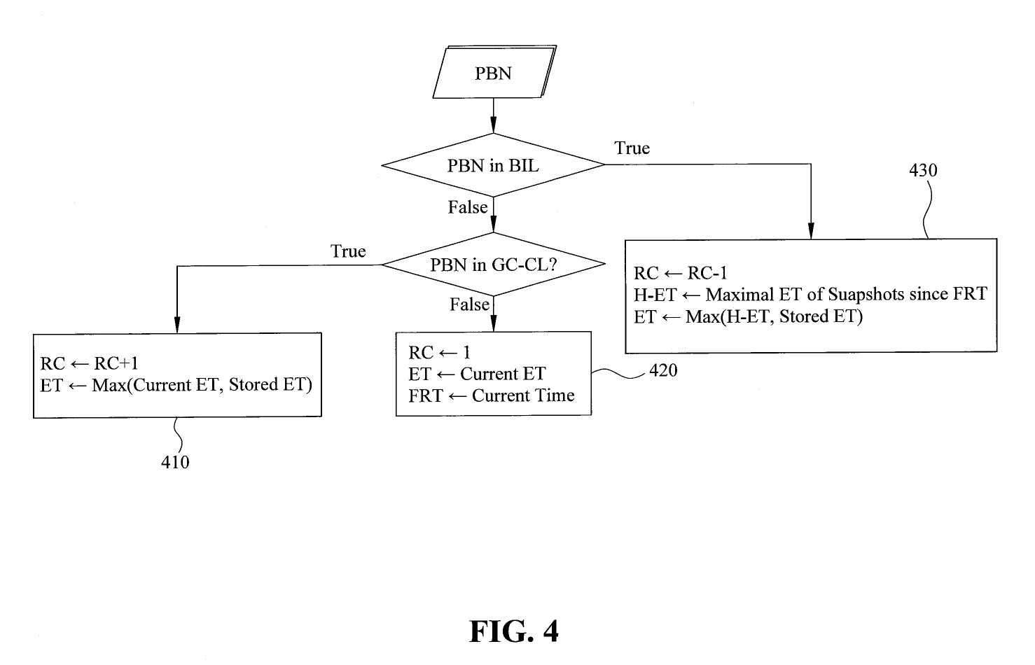

Each changed block may associate a corresponding triple of (RC, ET, FRT), where RC is the reference count of a physical block due to de-duplication, ET represents the expiration time of the physical block, and FRT is the first referral time of the physical block. FRT is used to update ET accurately. FIG. 1 shows an exemplary triple of (RC, ET, FRT) for an exemplary changed block, consistent with certain disclosed embodiments. In FIG. 1, physical block 320 associates a triple of (1, 700, 600), where 1 is the reference count of physical block 320, 700 is the expiration time of an initial backup image 100 and physical block 320 of backup image 100, and 600 is the expiration time of a backup image 110. FRT is used to update ET when the reference count is de-referenced. The details may be found later in FIG. 4.

At the de-duplication time, there are two lists as the input. One list is a changed list (CL) at the current time. The changed list CL may be a list with each entry including such as logical block number (LBN), physical block number (PBN) and referred flag. The referred flag may indicate whether an associated physical block is referred or not. The other list is a before-image list (BIL) including previous versions of the first overwrites at the current time for each overwritten block. When changed list is not empty, LBN and PBN are extracted from the changed list. Physical blocks referred in CL increment their RC, update ET, and update FRT accordingly. Those physical blocks referred in BIL decrements their RC. All these changed physical blocks are added to a garbage collection related change list (GC-CL), which may be an incremental list sorted by the physical block number to speed up the updates to GC-CL. Each entry of the GC-CL may include fields of PBN, RC, ET, backup image identifier, and so on. The backup image identifier may be used to lookup the FRT.

Physical blocks referred in BIL decrement their RC and update ET. If RC drops to zero, the physical block is moved to a recycle list (RL). Note that FRT is not updated for physical blocks in BIL. At the garbage collection time, the RL is checked; physical blocks are checked for their ET. Those blocks that have expired are garbage collected. Because the size of the GC-CL is proportional to the size of incremental changes and incremental changes are small compared to the full block set, the disclosed garbage collection technique may be scalable to the physical capacity.

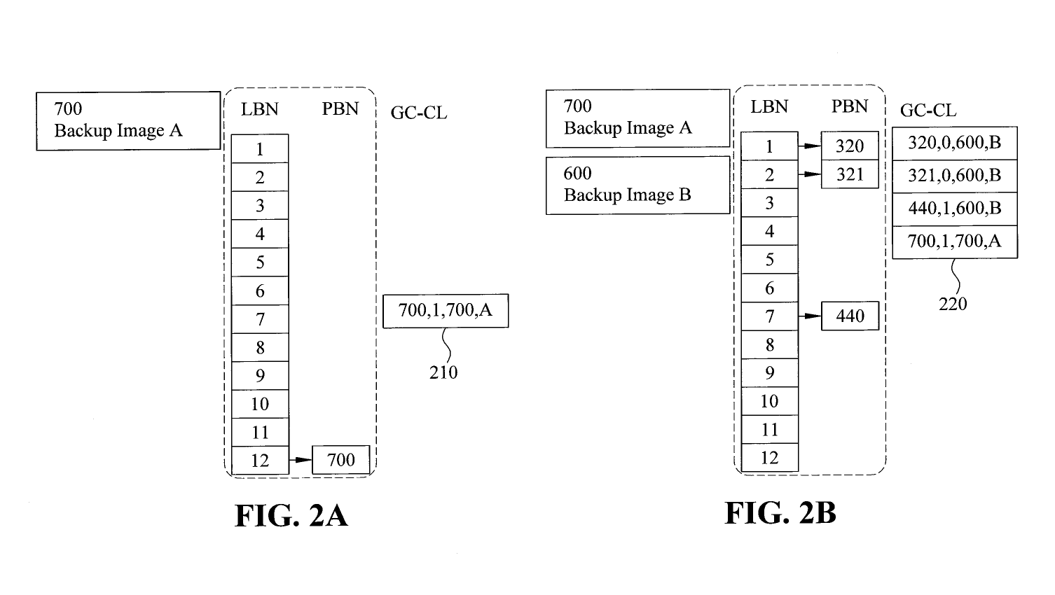

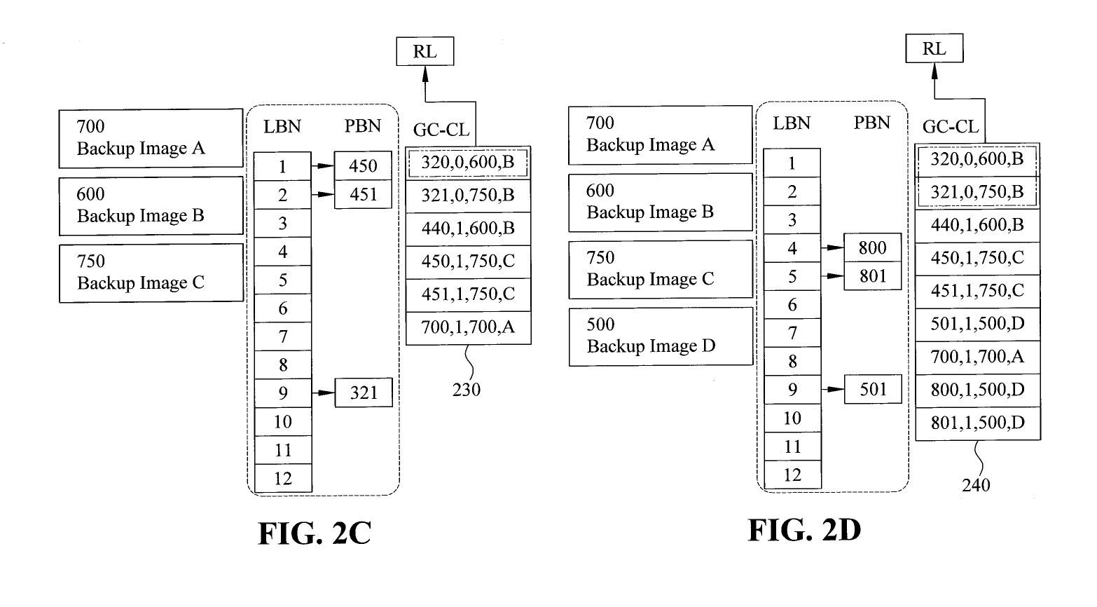

At the backup time, the CL and the BIL of each snapshot are used to update the GC-CL. FIGS. 2A-2D show a working example of updating the GC-CL and the RL for backup images A-D at backup time, consistent with certain disclosed embodiments. Referring to FIG. 2A, backup image A is an initial backup and there does not exist an L2P mapping yet for all logical block addresses (in total 12 logical blocks with logical block numbers (LBNs) 1-12. Only logical block 12 has a corresponding physical block address, 700. Backup image A has the expiration time of 700. At this moment, the GC-CL is shown as GC-CL 210. As may be seen, an entry for the GC-CL may have four fields. For this example, the first field represents physical block number 320, the second field represents reference count 1 of physical block 320, the third field and the fourth field represent the expiration time 700 of physical block 320 and the associated backup image A, respectively.

Referring to FIG. 2B, for backup image B, according to L2P mapping for backup image B, logical block address 1, 2, and 7 are written. CL records the written physical blocks 320, 321, and 440. Note that the expiration time of all three physical blocks 320, 321, and 440 are updated as 600, the expiration time of backup B. At this moment, an updated GC-CL is shown as GC-CL 220 by adding the three entries for physical blocks 320, 321, and 440 to GC-CL 210.

Referring to FIG. 2C, for backup image C, according to L2P mapping for backup image C, logical blocks 1, 2, and 9 are written. Note that logical block 9 shares the same physical block (physical block 321) as the old version of logical block 2. The expiration time of physical block 321 is updated to 750, the expiration time of backup C. Also, logical blocks 1 and 2 are mapped to new physical blocks 450 and 451, respectively. Therefore, both physical blocks 450 and 451 have the reference count 1 and the expiration time of backup C. Physical block 320 belongs to the before image list of a snapshot, therefore the reference count of block 320 drops to zero (i.e. decrement by 1). At this moment, an updated GC-CL is shown as GC-CL 230.

Referring to FIG. 2C, for backup image D, logical blocks 4, 5, and 9 are overwritten. Note that logical block 9 is mapped to a new physical block 501. Therefore, physical block 501 has the reference count 1 and the expiration time 500, the expiration time of backup image D. Also, reference count of physical block 321 drops to 0 because physical block 321 belongs to the before image list of a snapshot. At this moment, an updated GC-CL is shown as GC-CL 240.

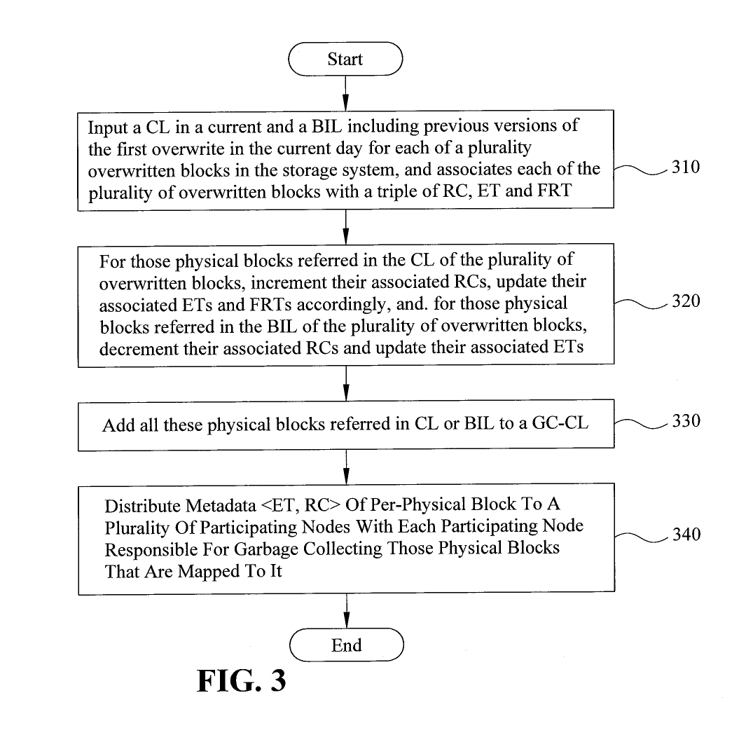

Accordingly, FIG. 3 shows an exemplary flowchart of a scalable and parallel garbage collection method for incremental backups with data de-duplication on a storage system, consistent with certain disclosed embodiments. Referring to FIG. 3, In step 310, input a CL at a current time and a BIL including previous versions of the first overwrite at the current time for each of a plurality overwritten blocks in the storage system, and associates each of the plurality of overwritten blocks with a triple of RC, ET and FRT. Wherein, the triple of RC, ET and FRT are defined as before. In step 320, for those physical blocks of the plurality of overwritten blocks, which are referred in the CL, increment their associated RCs, update their associated ETs and FRTs accordingly, and. for those physical blocks of the plurality of overwritten blocks, which are referred in the BIL, decrement their associated RCs and update their associated ETs. In step 330, add all these physical blocks referred in CL or BIL to a GC-CL. In step 340, distribute metadata <ET, RC> of per-physical block to a plurality of participating nodes with each participating node responsible for garbage collecting those physical blocks that are mapped to it.

In step 340, each participating node may move those physical blocks having zero reference count in the GC-CL, to a recycle list (RL) and garbage collecting those physical blocks having expired in the RL. In other words, when the reference count drops to 0, the corresponding physical block is removed from the GC-CL and appended to the RL for garbage collection, and the expiration time indicates when the physical block expires.

FIG. 4 shows an exemplary flowchart illustrating how the triple of ET, RC and FRT is updated for garbage collection, consistent with certain disclosed embodiments. For a physical block in an initial backup image, it has RC equal to 1 and ET equal to expiration time of the initial backup image. Referring to FIG. 4, the expiration time may be updated as follows. When a physical block is referenced due to de-duplication, its expiration time is updated as the latest expiration time between the stored expiration time and the expiration time of the snapshot containing the de-duplicated physical block (see step 410). If the physical block is previously not in GC-CL, FRT is set to the current time (see step 420). When a physical block belongs to the BIL of a snapshot, i.e. the physical block is overwritten, its expiration time is updated as the larger one between the stored one and the largest one associated with all previous snapshots since the FRT of the physical block (see step 430), where H-ET indicates the largest ET associated with all previous snapshots since the FRT of the physical block.

The reference count may be updated as follows. When a physical block is referenced due to data de-duplication, the reference count is incremented for the physical block (see step 410). When a physical block belongs to the BIL of a snapshot, the reference count is decremented for the physical block (see step 430). If the physical block is previously not in GC-CL, RC sets to 1 and ET equal to expiration time of the current ET (see step 420).

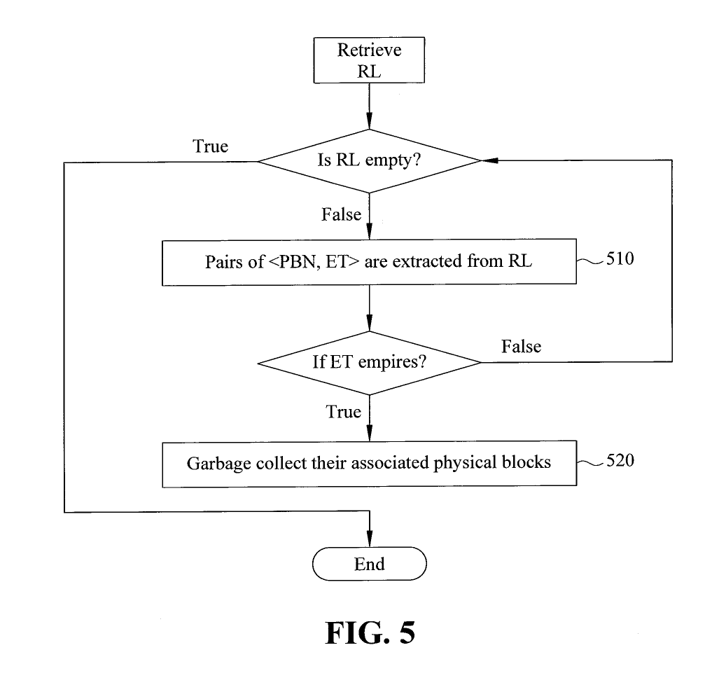

RL is an incremental list. It is initialized as NIL because initially there is no de-duplication among main-storage volumes. This incremental list may be used to find out physical data blocks to garbage collect. FIG. 5 shows an exemplary flowchart illustrating how garbage collection proceeds based on the RL, consistent with certain disclosed embodiments. Referring to FIG. 4, after retrieval of RL, when RL is not empty, pairs of <PBN, ET> are extracted from RL, as shown in step 510. When expired ETs are found, garbage collect their associated physical blocks, as shown in step 520. Basically, all physical blocks in RL are checked to recycle those physical blocks that already expire.

For the working example of FIG. 2, at the garbage collection time (i.e. after backup image D is created), those entries in GC-CL 240 with zero reference count are extracted to form RL. In that particular example, physical block 320 and 321 are included in RL. Physical blocks 320 and 321 may be recycled at time 600 and 750, respectively.

Furthermore, for example, when a GC-CL cannot fit into a RAM on one node, the garbage collection tasks may be distributed to multiple participating data nodes. Because a particular hash value resides on one data node and a physical block is represented by its hash value, the triple <RC, ET, FRT> of a particular physical block is associated with a fingerprint. The physical block is distributed to a particular data node based on the consistent hash of the fingerprint. The GC-CL is distributed across all data nodes based on consistent hash values of a plurality of physical blocks in a storage system. Each data node may independently decide which physical block to recycle because the triple <RC, ET, FRT> exclusively belongs to a data node based on the fingerprint of the physical block.

All physical blocks in GC-CL have their fingerprints computed, where a fingerprint is a hash value of the block content. Each fingerprint is long enough to have a very low collision rate. For example, a fingerprint may be 20-byte long. Each fingerprint is then mapped through consistent hashing to 1 of 4 participating nodes.

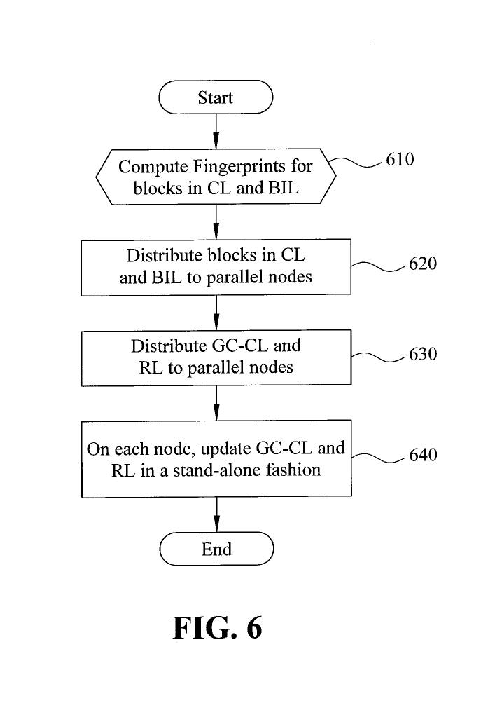

FIG. 6 shows an exemplary schematic view illustrating how GC-CL and RL are distributed to participating parallel nodes based on the consistent hashing of the fingerprint of the physical block, consistent with certain disclosed embodiments. Referring to FIG. 6, fingerprints for all physical blocks in the CL or the BIL are computed, as shown in step 610. In step 620, all physical blocks in the CL or the BIL are distributed to the plurality of parallel nodes. In step 630, GC-CL and RL are distributed to the plurality of parallel nodes based on the consistent hashing of the fingerprints of the physical blocks. In step 640, GC-CL and RL are updated on each of the plurality of parallel nodes in a stand-alone fashion.

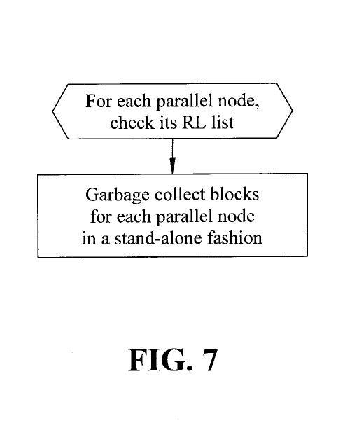

FIG. 7 shows how parallel garbage collection works with participating parallel nodes, consistent with certain disclosed embodiments. Referring to FIG. 7, for each of participating parallel nodes, check its RL list, as shown in step 710. Then, each of participating parallel nodes garbage collects physical blocks in a stand-alone fashion, as shown in step 720. In other words, each of participating node garbage-collects physical blocks independently based on its RL list.

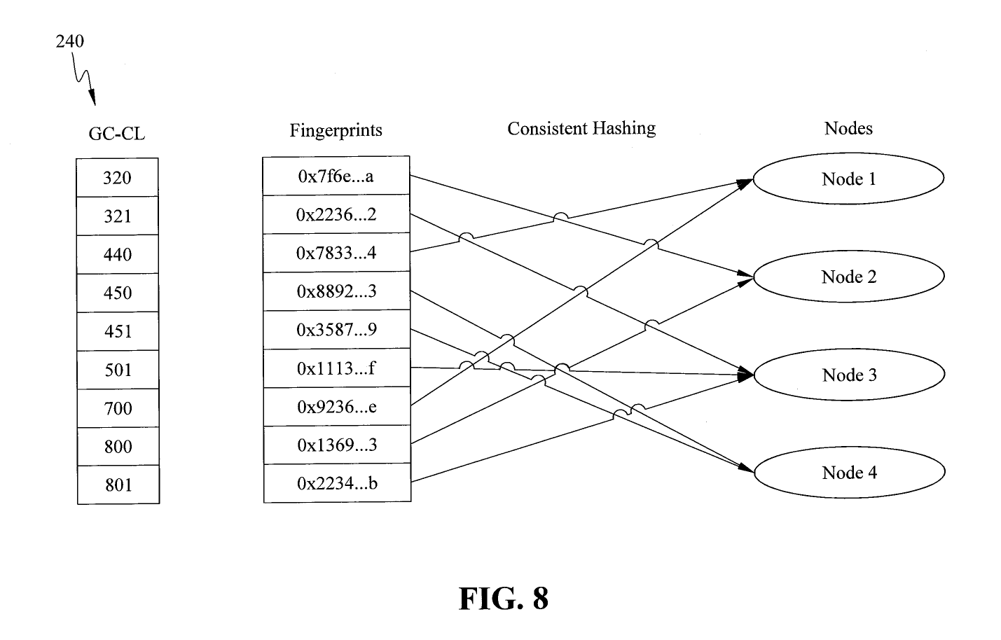

FIG. 8 shows a working example on how to distribute a GC-CL to 4 participating nodes, according to the flowchart of FIG. 6, consistent with certain disclosed embodiments. Referring to FIG. 8, all physical blocks in GC-CL 240 have their fingerprints computed (a fingerprint is a hash value of the block content). Each fingerprint is long enough to have a very low collision rate. For example, a fingerprint may be 20-byte long and physical block 450 in GC-CL 240 may have a fingerprint of 0x8892 . . . 3. Each fingerprint is then mapped through consistent hashing to 1 of 4 participating nodes. In this working example, Node 1 accommodates physical blocks 440 and 700. Node 2 accommodates physical blocks 320 and 800. Node 3 accommodates physical blocks 321, 501 and 801. Node 4 accommodates physical blocks 450 and 451. After the distribution, each node may independently garbage collect physical blocks allocated to it. For example, Node 4 is responsible to garbage collects physical block 450 and 451.

Accordingly, an exemplary experiment may be performed to demonstrate the disclosed garbage collection is scalable to incremental changes. In the exemplary experiment, it may create many (for example, 1000) backup images for a logical volume with an expiration time of a fixed time (for example, 1000 seconds). Each backup image overwrites a previous backup image by 1%. The 1% of backup image overwrites write to the same portion of the logical volume. Each backup image is taken 10 seconds after the previous backup image. At the end of the time window (1000*10=10000 seconds), trigger the disclosed garbage collection and check the available free blocks. In a short time (less than 1000 seconds, which is mainly used to scan the per-physical block metadata.), it may be found that the number of available free blocks increases by 2.56 G. Therefore, the disclosed garbage collection is based on incremental block changes.

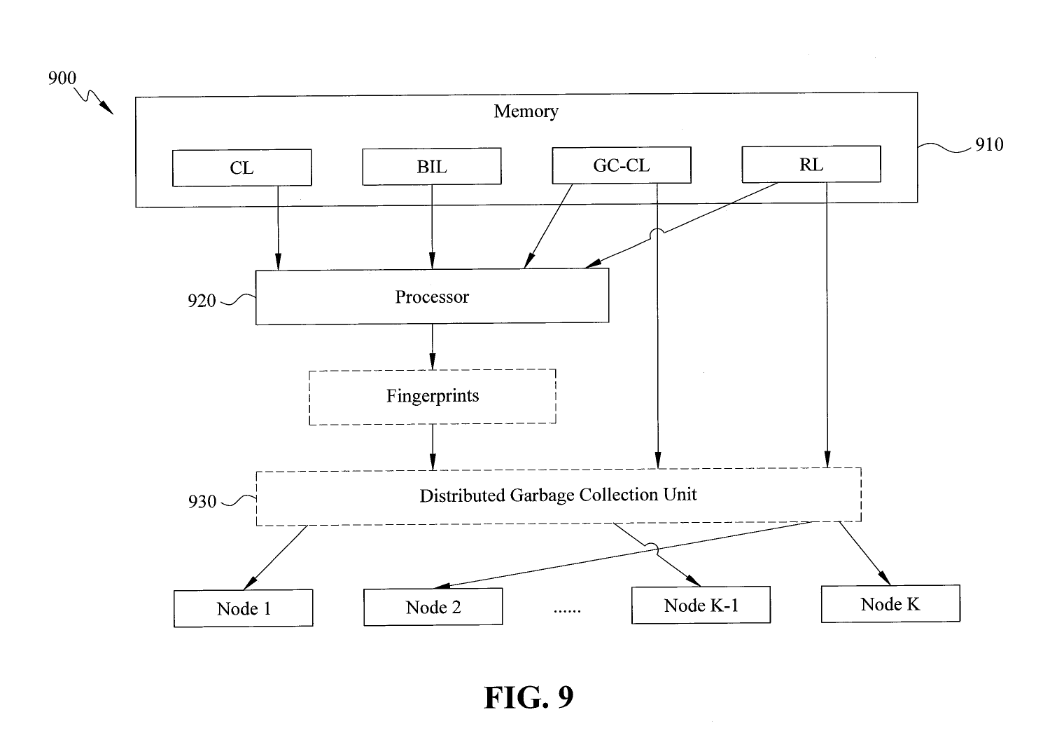

Referring now to FIG. 9, an exemplary scalable and parallel garbage collection system for incremental backups with data de-duplication, consistent with certain disclosed embodiments, is illustrated. It should be understood that embodiments described herein may be entirely hardware or including both hardware and software elements. Exemplary embodiments of the scalable and parallel garbage collection system may comprise a computer program product accessible from a computer-usable or computer-readable medium, and a processor that may perform garbage collection as mentioned above. A computer-usable or computer-readable medium may include any apparatus that stores such as the CL, the BIL, the GC-CL and RL, for use by or in connection with the processor. The computer-usable or computer-readable medium may be a semiconductor or solid state memory, a removable computer disk, a random access memory (RAM), a rigid magnetic disk and an optical disk, etc.

Returning to FIG. 9, scalable and parallel garbage collection system 900 may comprise a memory 910 and a processor 920. Wherein memory 900 stores an inputted CL at a current time, an inputted BIL including previous versions of the first overwrite at said current time for each of a plurality of overwritten physical blocks in a storage system, a GC-CL to record the related information for incremental changed physical blocks and a RL to garbage collect the physical blocks to be recycled. Processor 910 may perform: associating each of the plurality of overwritten blocks with a RC due to de-duplication, an ET, and a FRT; for those physical blocks referred in the CL of the plurality of overwritten blocks, incrementing their associated RCs and updating their associated ETs, and. for those physical blocks in the BIL of the plurality of overwritten blocks, decrementing their associated RCs and updating their associated ETs; and adding all these physical blocks referred in the CL or the BIL to the GC-CL. System 900 further distributes metadata <ET, RC> of per-physical block to a plurality of participating nodes with each participating node responsible for garbage collecting those physical blocks that are mapped to it. Each participating node may move those physical blocks having zero reference count in the GC-CL, to the RL; and garbage collecting those physical blocks having expired in the RL.

Scalable and parallel garbage collection system 900 may further includes a distributed garbage collection unit 930 for distributing the metadata <ET, RC> of per-physical block to a plurality of participating nodes based on consistent hashing values of a plurality of fingerprints for all physical blocks in the GC-CL. The garbage collection unit 930 may also distribute the GC-CL and the RL to the plurality of participating nodes, such as Node 1˜Node K. The distribution of the GC-CL and the RL may further include the steps of 610˜640 as shown in FIG. 6. After distribution of metadata <ET, RC> of per-physical block to the plurality of participating nodes, each participating node independently garbage collects physical blocks which are mapped to it, as described in FIG. 7.

In summary, the disclosed exemplary embodiments may provide a scalable and parallel garbage collection method and system for incremental backups with data de-duplication, to save a lot of disk I/Os to access garbage-collection-related metadata and reduce the size of garbage-collection-related metadata on each individual node, via the schemas of limiting the garbage collection to incremental changes and distributing garbage collection tasks to a plurality of participating nodes. For garbage collection, each physical block may associate with an expiration time and a reference count. When the reference count drops to zero, the physical blocks are recycled based on the expiration time.

Although the disclosed has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A scalable and parallel garbage collection method for incremental backups with data de-duplication on a storage system, comprising:
inputting a changed list (CL) at a current time and a before-image list (BIL) including previous versions of the first overwrite at said current time for each of a plurality overwritten physical blocks in said storage system and associating each of said plurality of overwritten blocks with a reference count (RC) due to de-duplication, and an expiration time (ET);
for those physical blocks referred in said CL of said plurality of overwritten blocks, incrementing their associated RCs and updating their associated ETs, and. for those physical blocks in said BIL of said plurality of overwritten blocks, decrementing their associated RCs and updating their associated ETs;
adding all the physical blocks referred in said CL or said BIL to a garbage collection related change list (GC-CL); and
distributing metadata <ET, RC> of per-physical block to a plurality of participating nodes with each participating node responsible for garbage collecting those physical blocks that are mapped to it.

2. The method as claimed in claim 1, wherein each participating node responsible for garbage collecting those physical blocks that are mapped to it further includes moving those physical blocks having zero reference count in said GC-CL, to a recycle list (RL) and garbage collecting those physical blocks having expired in said RL.

3. The method as claimed in claim 1, wherein said garbage collecting is distributed across said plurality of participating nodes based on consistent hash values of said plurality overwritten physical blocks.

4. The method as claimed in claim 2, wherein, each of said plurality of participating nodes independently garbage collects physical blocks that are mapped to it.

5. The method as claimed in claim 1, wherein updating said expiration time further includes:
when a physical block is referenced due to de-duplication, its expiration time is updated as the latest expiration time between a stored expiration time and the expiration time of a snapshot containing the de-duplicated physical block;
if the physical block is previously not in said GC-CL, said FRT is set to said current time; and
when said physical block belongs to said BIL of a snapshot, its expiration time is updated as the larger one between a stored one and a largest one associated with all previous snapshots since said FRT of said physical block.

6. The method as claimed in claim 1, wherein updating said reference count further includes:
when a physical block is referenced due to data de-duplication, said RC is incremented for the physical block;
when the physical block belongs to said BIL of a snapshot, said RC is decremented for the physical block; and
If the physical block is previously not in said GC-CL, then aid RC is set s to 1.

7. The method as claimed in claim 2, wherein said GC-CL and said RL are distributed to said plurality of participating nodes based on a consistent hashing of a plurality of fingerprints of said plurality overwritten physical blocks.

8. The method as claimed in claim 7, wherein said GC-CL and said RL are distributed to said plurality of participating nodes further includes:
computing said plurality of fingerprints for all physical blocks in said CL or said BIL;
distributing all physical blocks in the CL or the BIL to said plurality of participating nodes;
distributing said GC-CL and said RL to said plurality of parallel nodes based on a consistent hashing of said plurality of computed fingerprints; and
for each of said plurality of participating nodes, updating its distributed GC-CL and RL in a stand-alone fashion.

9. The method as claimed in claim 1, wherein said GC-CL is an incremental list with each entry at least containing a physical block number, a RC, an ET, and a backup image identifier.

10. The s method as claimed in claim 1, wherein said CL is a list with each entry at least containing a logical block number, a physical block number and a referred flag, and said referred flag indicates whether an associated physical block is referred or not.

11. A scalable and parallel garbage collection system for incremental backups with data de-duplication on a storage system, comprising:
a memory for storing a changed list (CL) at a current time, a before-image list (BIL) including previous versions of the first overwrite at a current time for each of a plurality of overwritten physical blocks in said storage system, a garbage collection related change list (GC-CL) and a recycle list (RL); and
a processor for performing:
associating each of the plurality of overwritten blocks with a RC due to de-duplication, an ET, and a FRT;
for those physical blocks referred in said CL of the plurality of overwritten blocks, incrementing their associated RCs, updating their associated ETs and FRTs, and for those physical blocks in said BIL of the plurality of overwritten blocks, decrementing their associated RCs and updating their associated ETs; and
adding those physical blocks referred in said CL or said BIL to a GC-CL;
said system further distributes metadata <ET, RC> of per-physical block to a plurality of participating nodes with each participating node responsible for garbage collecting those physical blocks that are mapped to it.

12. The system as claimed in claim 11, wherein said GC-CL records related information for a plurality of incremental changed physical blocks.

13. The system as claimed in claim 11, wherein said RL garbage collects at least one of said plurality of overwritten blocks to be recycled.

14. The system as claimed in claim 11, wherein each of said plurality of participating nodes moves those physical blocks having zero reference count in said GC-CL, to said RL; and. garbage collecting those physical blocks having expired in the RL.

15. The system as claimed in claim 11, said system further includes a distributed garbage collection unit to distributes metadata <ET, RC> of per-physical block to said plurality of participating nodes, based on consistent hashing values of a plurality of fingerprints.

16. The system as claimed in claim 15, wherein said distributed garbage collection unit distributes said GC-CL and said RL to said plurality of participating nodes.

17. The system as claimed in claim 15, wherein after distribution of metadata <ET, RC> of per-physical block, to said plurality of participating nodes, each of said plurality of participating nodes independently garbage collects physical blocks that are mapped to it.
